(19) United States
(12) Patent Application Publication
(10) Pub. No.: US 2015/0178728 A1
(43) Pub. Date: Jun. 25, 2015

(54) METHOD AND SYSTEM OF SELECTIVE CONTENT DELIVERY

(71) Applicant: ChaCha Search, Inc, Carmel, IN (US)

(72) Inventor: Eugene M. O'Donnell, Fishers, IN (US)

(21) Appl. No.: 14/576,332

(22) Filed: Dec. 19, 2014

Related U.S. Application Data
(60) Provisional application No. 61/918,766, filed on Dec. 20, 2013.

(51) Int. Cl. G06Q 20/40; G06Q 30/02

(52) U.S. Cl. CPC G06Q 20/40; G06Q 30/0275; G06Q 30/0277

(57) ABSTRACT

A system and method of selectively distributing content based on verification of preferences. Access rights may be determined based on a type of content requested and type of content element which may be provided as secondary content. Compensation for a content provider may be determined based on secondary content presented and/or suppressed when primary content is provided.

### BACKGROUND

1. Field of the Invention

The present invention is related to selective presentation of content, and more specifically to a method and system for compensating content providers based on the presence or absence of promotional content.

2. Description of the Related Art

In a system wherein content is published it is common for the publisher to support the publication using advertising materials. This practice began with printed media such as newspapers and magazines and has continued with electronic publications such as radio, and television, websites, mobile apps and other forms of publication of content.

In many instances consumers of content may object to the presence of advertising. Several systems have been developed in order to block advertising, such as U.S. Pat. No. 8,375,090, or U.S. Pat. No. 5,870,151, or software products such as the browser plug-in AdBlock and AdBlock Plus.

Unfortunately such systems may significantly affect the profitability of a provider of content. In particular if a large enough percentage of users adopts ad blocking software an advertising supported content provider may be unable to continue to operate. For this reason some content providers will not provide web pages to users who are using an ad blocking extension. Sites which implement this strategy may experience a loss of traffic which can adversely affect advertising rates which are based on traffic volume.

Alternately, a content provider may shift to a subscription-only model of operation. This presents difficulties for a content provider as many users feel that they do not use a sufficient amount of content to deal with the expense and trouble of subscribing to a content provider, especially when content may be viewed from dozens or even hundreds of sites in any given month and viewing habits may vary widely.

For these and other reasons, a method and system of selective content delivery would be greatly appreciated.

### SUMMARY

A system is provided which includes a user device which may request content, a content provider device which may deliver content, a secondary content element server device which may provide a content element which is to be selectively delivered to a user responsive to a content request from the user device. It is envisioned that many user devices, content provider devices and secondary content element servers may be incorporated in the system.

When a request is received by the content provider an authentication process is performed to determine whether a secondary content element such as an advertisement is to be delivered responsive to the request. If the request is authenticated, the content is presented to excluding the secondary content element. If the request is not authenticated, the content is presented including the secondary content element.

Authentication may be performed according to any suitable means. For example, a username and password system might be used for authentication. A browser extension might incorporate an authentication mechanism. A browser extension might improve a user experience and might include more sophisticated security measures to prevent unauthorized use of content.

If content is delivered including secondary elements such as advertisements a user might not be required to provide compensation to a content provider. If content is delivered excluding secondary elements a user may be required to provide compensation in return for receiving content. Compensation owed by a user for content may be tracked in various ways. A browser extension may record page views and/or other activities of a user which may accrue compensation owed based on factors such as a number of page views, a website URL, a download of content, etc. A content provider may record requests, actions, etc. associated with an identifier of a user which may be used to determine compensation. A third-party server may record information of actions of a user and/or a content provider which may be used to determine compensation.

Compensation associated with a request may be determined based on compensation associated with secondary elements. A value associated with secondary elements when delivered with content may be used to determine a value of the content when delivered without the elements. For example, if a web page includes advertisements with a value of two dollars per thousand, an equivalent web page delivered without advertisements might have an equivalent value. Adjustments might be applied to increase or decrease the relative value of content. For example, if users prefer pages without advertisements, compensation for similar content might be higher if the content is delivered without secondary content elements.

A user might be notified when requested content may be delivered without advertisements and be provided an option of receiving secondary content or not. A user might be notified of an amount of compensation which is associated with content. A user may provide compensation according to any suitable method. For example, a user might pay a metered fee, a subscription fee, etc. based on usage of content.

A content provider might receive compensation in a manner similar to an advertising supported model wherein a payment is made based on page views and/or advertisement views based on counts by an advertiser or a third party advertising server.

A ‘mixed’ compensation system might be used. A user might elect to receive advertisements which meet a criterion while not receiving secondary content elements which do not meet the criterion. For example, if content costs more than a particular amount a user might accept advertising content or if an advertisement is not video content, not a pop-up, associated with an advertiser, etc. a user might accept to receive that content or element. Likewise a content provider might identify some advertisements which would be blocked when a criteria is met, but which are presented otherwise. Compensation for many content providers may be aggregated such that a user is not required to subscribe to a particular type of content, but may access desired content which is used infrequently without a subscription.

### BRIEF DESCRIPTION OF THE DRAWINGS

Aspects and advantages of the disclosure will become apparent and more readily appreciated from the following description of the embodiments, taken in conjunction with the accompanying drawings, of which:

FIG. 1 is a block diagram of an exemplary system embodiment.

FIG. 2 is a flowchart of fulfilling a request for content.

FIG. 3 is a flowchart of obtaining content by a user.

FIG. 4 is a flowchart of fulfilling a request for selective content.

### DETAILED DESCRIPTION OF THE PREFERRED EMBODIMENTS

Reference will now be made in detail to the present embodiments discussed herein. Examples are illustrated in the accompanying drawings, wherein like reference numerals refer to the like elements throughout. The embodiments are described below to explain the disclosed system and method by referring to the figures. It will nevertheless be understood that no limitation of the scope is thereby intended, such alterations and further modifications in the illustrated device, and such further applications of the principles as illustrated therein being contemplated as would normally occur to one skilled in the art to which the embodiments relate. As used herein, words importing the singular shall include the plural and vice versa unless specifically counter indicated.

A system is provided which includes a tracking server system which may provide elective content such as advertisements, elective content systems which may provide secondary content such as promotional materials for presentation, content provider systems which may provide content which may or may not include secondary content to users, and user systems which may request content from the content provider systems, a database recording activities by users, advertisers, and content providers and a network.

The tracking server system may record information of requests for secondary content or “promos”, and may provide promos to content providers based on targeting information provided to the tracking server system. Compensation provided by users who may elect not to receive particular advertisements and/or other content may be determined based on compensation earned by the display of promos or advertisements to other users based on similar targeting information for content published on similar publishing properties by the content providers. Compensation from users may be obtained by any suitable means. In at least one embodiment, the tracking server system may obtain compensation from a user and may provide compensation to publishers or content providers.

As used herein, a “request” or query or question means a request for information, products, and/or services. A request or query may include various types of media, and may be provided by any system which may establish communication with a server and/or other devices accessible via a network such as the internet.

A “user” is a person who submits a request and may receive any type of information responsive to a request. A user may be any person or entity. A “publisher” is any person or entity which may distribute content to a user responsive to requests. A publisher may distribute content including advertisements or other forms of secondary content. Content of a publisher may be accessible via any suitable communication medium such as Internet Protocol (IP), voice, text (e.g., SMS), social media, Instant Messaging, etc. A publisher may distribute content via an application or “App” and/or a browser functionality of a user device.

An “advertiser” is any person and/or entity which may provide promotional information or content which is not produced by a target of a request for content or “advertisements” or “elective content” to be delivered. Elective content elements may take various forms and/or may include media of any sort which can be delivered to a user device.

Tracking of user activities may be performed in various ways. For example, techniques such as browser cookies, web beacons, or ‘pixel tags’ may be used to track user activities. In at least one embodiment, an application resident on a user device may be used to provide preference and/or authentication information of a user to a content provider or publisher, a tracking server system, and/or an advertiser. As payments may be based on cost per thousand (CPM) impressions, page views or other units of consumption of content may be used as a form of metering of usage.

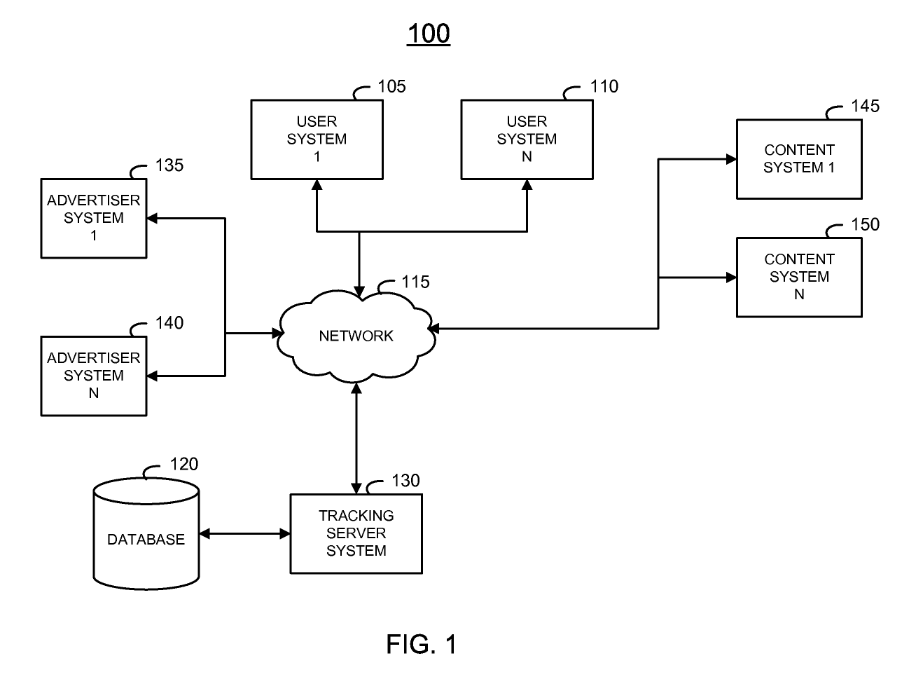

As illustrated in FIG. 1, system 100 includes user systems 105, 110, a network 115 such as the Internet, a tracking server system 130, a database 120, which may comprise various records, advertiser systems 135, 140, and content systems 145, 150.

While only a few systems associated with a user, a publisher, and an advertiser are depicted in FIG. 1 it is within the scope of the disclosure for multiple systems for a user, a publisher, a tracking server system and an advertiser to be utilized. In particular it is envisioned that many user, publisher, and advertiser systems may be implemented. The tracking server system 130 may be a composed of many components as described further herein.

The network 115 may be a global public network of networks (i.e., the Internet) and/or may consist in whole or in part of one or more private networks and communicatively couples the user systems 105, 110, the advertiser systems 135, 140, and the content systems 145, 150 with the other components of the system such as the tracking server system 130, and the database 120. The network 115 may include one or more wireless networks which may enable wireless communication between the various elements of the system 100. For example, the tracking server system 130 may receive messages which may be routed via a wireless network controlled by a wireless service to the user systems 105, 110. A wireless service may receive messages from the content systems 145, 150 via a wireless network which is a part of the network 115, and provide the messages to the tracking server system 130 via an internet connection which is part of the network 115.

The tracking server system 130 allows interaction to occur among the user systems 105, 110, the advertiser systems 135, 140, and the content systems 145, 150. For example, a request can be transmitted from the user system 105 to the content system 145, which may send a request to the tracking server system 130, which may provide information obtained from the database 120, which may include an advertisement or elective content provided by the advertiser system 140 to the content system 145, which may respond to the user system 105. Any type of communication between users, a tracking system, advertisers, and/or publishers of content may be mediated and/or facilitated by the tracking server system 130, and/or other elements of the system 100.

The tracking server system 130 is communicatively coupled with the database 120. As will be described herein in further detail below, the database 120 includes data that is processed in association with operation of the embodiments. Although FIG. 1 illustrates the database 120 as a separate component of the system, the database 120 may be integrated with the tracking server system 130. Further, the records maintained in the database 120 may be stored in any typical manner, including in a Network Attached Storage (NAS), a Storage Area Network (SAN), RAID, etc., using any typical or proprietary operating system (OS) such as Microsoft Windows XP®, Linux, iOS®, Android®, etc. and any database software such as DB2®, Informix®, Microsoft® SQLServer™, MySQL®, Oracle®, etc., and may also be a distributed database on more than one server. Elements of the database 120 may reside in any suitable elements of the system 100. Any or all elements of the system 100 may include any or the entirety of the database 120.

The user systems 105, 110, the advertiser systems 135, 140, the content systems 145, 150, and the tracking server system 130 may include equipment, software, systems and personnel required to send and/or receive messages between the user systems 105, 110, the advertiser systems 135, 140, the content systems 145, 150 and/or the tracking server system 130 using the network 115. The database 120 includes information which may allow the tracking server system 130 to establish communication between any or all of the elements of the system 100.

An user system, a publisher system, an content system and/or a tracking server system may be a desktop, portable, or tablet computer using an operating system such as Windows®, iOS®, Android®, etc., a mobile phone, a smart phone, a PDA, a server system, a landline phone, a specialized communication terminal, a terminal connected to a mainframe, or any other suitable communication hardware and/or system. The tracking server system 130, an advertiser system, and/or a content system may include one or more servers, computers, etc. For example, servers such as the PowerEdge® 2900 by Dell, or the BladeCenterJS22 by IBM, or equivalent systems might be used to implement elements of the distribution system 130. The distribution system 130 may utilize an operating system (OS) such as Microsoft Windows XP, Linux, iOS®, Android®, etc. Voice routing and packet switching may be accomplished using well established technologies such as those provided by Cisco, or other networking companies. After being presented with the disclosure herein, one of ordinary skill in the relevant art will immediately realize that any viable computer systems or communication devices known in the art which may provide media content to a person and communicate via a network may be used as user systems, content systems, advertiser systems and/or to implement the tracking server system 130.

A user may be identified by the tracking server system 130 based on information obtained from a user device or system. When a user system accesses the tracking server system 130 a user may be identified based on security information provided to the tracking server system 130. A user may obtain various information regarding publications and/or content with which elective content such as advertisements may be provided to users. A user may be able to obtain usage information regarding publishers, distribution channels, usage, compensation, and/or advertisements.

A user may be required to register with the tracking server system 130. As part of a registration process, at least one communication method is associated with a user. In at least one embodiment, a user may register with the tracking server system 130 and establish a username and password which are associated with the user. A user may login to the tracking server system 130 using a web browser or resident app functionality of the user system 110 in order to communicate with the tracking server system 130. One or more identifiers may be assigned to a user and may be used to identify content provided to a user. A user may provide profile information such as personally identifying information, geographic, background, affiliation, demographic, interest, category, etc. information. A user may provide information required to provide payment to a content provider and/or a provider of the tracking server system.

When a user is registered with the tracking server system 130 the user may have access to content available from the tracking server system 130. This may include sponsored content provided by the advertiser systems 135, 140, data indicated in the database 120, content provided by the content systems 145, 150, etc. A user may have access privileges based on factors such as payment information, usage data, geography, content viewed, etc.

A content provider may be required to register with the tracking server system 130. As part of a registration process, at least one communication method is associated with a publisher or content provider. In at least one embodiment, a publisher may register with the tracking server system 130 and establish a username and password which are associated with the publisher. A publisher may login to the tracking server system 130 using a web browser or application functionality of the content system 150 in order to communicate with the tracking server system 130. One or more identifiers may be assigned to a publisher which may be used to distribute content such as advertisements, images, etc., to a publisher, and may be used to track content usage associated with a publisher and/or distribution channel.

When a content provider or publisher is registered with the tracking server system 130 a publisher may have access to data available from the tracking server system 130. This may include content information of users, etc. A publisher may provide information of users to the tracking server system 130 and/or may receive advertisements targeted based on targeting information provided by the tracking server system 130. A publisher may provide information regarding unique users, user activities, etc., associated with content to the tracking server system 130. A publisher may provide content usage information to the tracking server system 130.

An advertiser may be required to register with the tracking server system 130. As part of a registration process, at least one communication method is associated with an advertiser or optional content provider. In at least one embodiment, an advertiser or secondary content provider may register with the tracking server system 130 and establish a username and password which are associated with the advertiser. An advertiser may login to the tracking server system 130 using a web browser or application functionality of the advertiser system 135 in order to communicate with the tracking server system 130. An advertiser system may provide content such as promotions or other optional content and may associate targeting information with content.

When an advertiser is registered with the tracking server system 130 an advertiser may have access to data available from the tracking server system 130. This may include targeting information associated with publishers, content, responders, editors, use of advertisements, compensation associated with advertisements, available targeting information, etc. An advertiser may target advertisements and/or content based on any available targeting parameters. An advertiser may provide content associated with a targeting parameter which may be distributed based on targeting information associated with content provided by publishers.

Records may be maintained in the database 120 which may be used to record the status of various items. Such records may be used to aid the targeting of content provided by advertisers, track activities of users, determine usage history of websites, publisher content, and advertisements, etc. For example, a user may activate an indicator distributed by a publisher, which may cause a request to be received by the tracking server system 130, which may obtain website activity information which may be used to select content to be provided to a user responsive to a request.

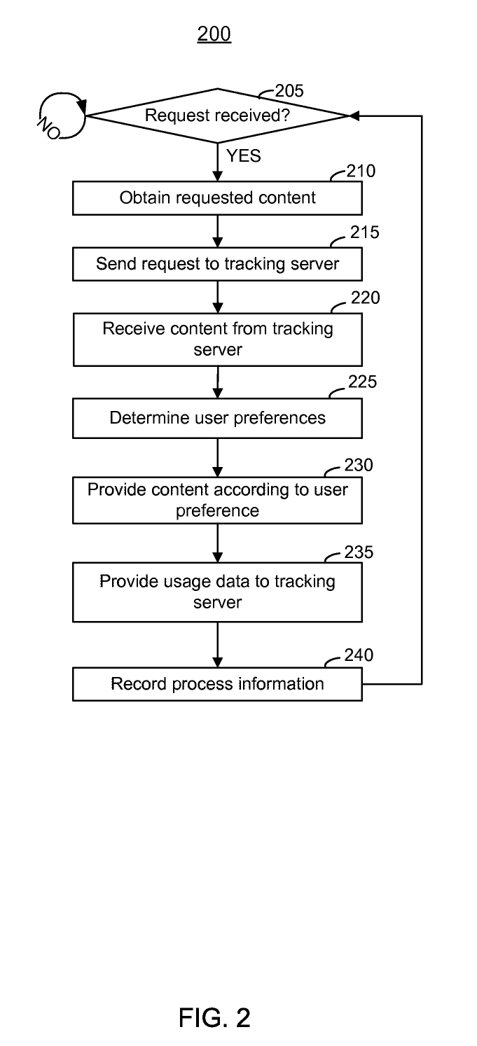

As illustrated in FIG. 2, a process 200 for providing content is provided. The process 200 may be performed in whole or in part by any suitable element of the system 100 (FIG. 1). In at least one embodiment, the process 200 is operative on a server associated with the content system 145.

In operation 205 (FIG. 2) a determination is made as to whether a request is received. If it is determined in operation 205 that a request is not received, control remains at operation 205 and process 200 continues. If it is determined in operation 205 that a request is received, control is passed to operation 210 and process 200 continues.

The determination in operation 205 may be made using various criteria. In at least one embodiment, if a message is received at a system associated with the content system 210 (FIG. 1), it may be determined that a request is received. For example, if a GET request indicating an identifier of an user is received at a server associated with the content system 120, it may be determined that a request is received. Any type of message may be received which may indicate that a request is received. For example, reception of an SMS message, a mobile web message, a message from an App, etc., may be used to determine whether a request is received. A request may be received directly from a user device and/or may originate through an intermediary such as the tracking system server 130. A request may include information which may be used to determine preferences and/or authorization associated with a user and/or a request.

In operation 210, requested content is obtained. Requested content may be any type of media and may include any suitable information. Control is passed to operation 215 and process 200 continues.

In operation 215, a request is sent to the tracking server. A request to the tracking server may include targeting information based on a user, and/or requested content. An identifier of a user may be shared with a tracking server. A tracking server request may include information of a publisher. A request to a content server may for example be generated by Xml or other ‘tags’ which are embedded in a web page of content which is requested. Control is passed to operation 220 and process 200 continues.

In operation 220, content is received from a tracking server. Content received from a tracking server may include advertisements, information of advertisements, verification information of a user, elective or optional content such as a survey, poll, game, etc. Control is passed to operation 225 and process 200 continues.

In operation 225 user preferences are determined. User preferences may include whether a user wishes to see advertisements, types of elective or secondary content which a user will accept, content in which a user will accept secondary content, an amount which a user is willing to pay to suppress a type of content, an amount of data which a user is willing to accept in advertising content, etc. A user may for example specify advertisers, types of advertisements (e.g., video, audio, coupons, discounts, images, URL's, pop-ups, pop-over/pop-under, Flash, etc.), which the user may accept and/or combinations thereof. Control is passed to operation 230 and process 200 continues.

In operation 230, content is provided according to user preference. Content may be provided based on expressed user preferences and/or implicit user preferences. For example, if a user has requested not to view advertisements but has not provided a suitable level of compensation a user preference is implicitly that of seeing the advertisement. Likewise, a user might prefer to exclude an advertiser who has successfully bid for a particular advertising placement, in which case a user might be blocked from receiving any or all content requested, might be charged a higher price for content, etc. Control is passed to operation 235 and process 200 continues.

In operation 235 usage data is provided to a tracking server. Usage data may include information of advertisements which are presented, suppressed, modified, etc. Usage data may include metrics such as page views, clicks (i.e., activation of controls), etc. which may be obtained by a content system. Usage data may affect compensation due to a content provider, a publisher, an advertiser, etc. and may affect compensation required from a user. Any actions taken by a user using input capabilities of a user device may be used to obtain usage information. For example, timing data, images, audio, tactile actions, etc. which indicate actions of a person operating a communications device may be used to obtain usage data. Control is passed to operation 240 and process 200 continues.

In operation 240, process information is recorded. Information of a request, a user, a publisher, a website, an advertiser, content, targeting parameters, user actions, compensation of a user, publisher, advertiser, etc., a rating, a ranking, etc. may be recorded. In at least one embodiment, process information is recorded in the database 120 (FIG. 1). Control is passed to operation 205 and process 200 continues.

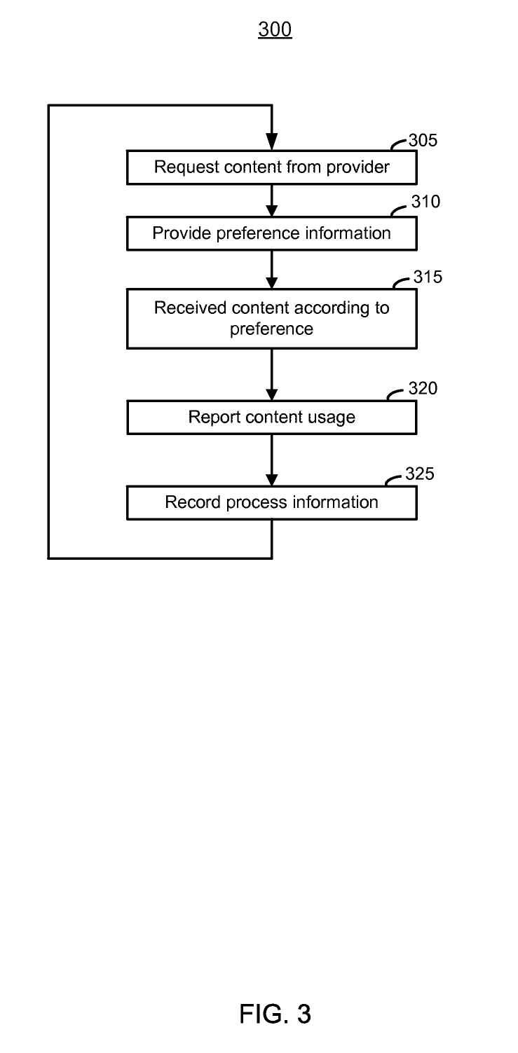

As illustrated in FIG. 3, a process 300 for providing content is provided. The process 300 may be performed in whole or in part by any suitable element of the system 100 (FIG. 1). In at least one embodiment, the process 300 is operative on a user system such as the user system 105 (FIG. 1). For example, an app and/or a browser functionality operative on a user device might perform any or all of the elements of the process 300.

In operation 305, content is requested from a provider. Requested content may be any type of media and may include any suitable information which may be obtained from a content provider. Control is passed to operation 310 and process 300 continues.

In operation 310, preference information is provided. Preference information which may be used to determine whether content is provided responsive to a request. For example, a browser and/or application may provide a one-time use token, an authorization code, etc. which may determine a response to a user request. Preference information may be provided without revealing personally identifying information of a user. Any type of preference information may be provided. For example, preferences as described herein above with respect to FIG. 2 may be delivered to a content provider. Control is passed to operation 315 and process 300 continues.

In operation 315, content is received according to preference. A user may receive content based on expressed preferences and/or based on preferences determined by a content provider and/or a tracking server system. Control is passed to operation 320 and process 300 continues.

In operation 320, content usage is reported. For example, a user device may report information such as page views, advertisements received, content received, content requested, preferences provided, etc. Usage information may be aggregated by a user device which may send usage information to a tracking server system. A cross-check may be performed between usage data reported by a user device and usage data reported by a content provider. Control is passed to operation 325 and process 300 continues.

In operation 325, process information is recorded. Information of a request, a user, a publisher, a website, an advertiser, content, targeting parameters, user actions, compensation of a user, publisher, advertiser, etc., a rating, a ranking, etc. may be recorded. In at least one embodiment, process information is recorded in the database 120 (FIG. 1). Local information of a user device may be obtained and/or updated based on process information and/or information received from a tracking system server. Control is passed to operation 305 and process 300 continues.

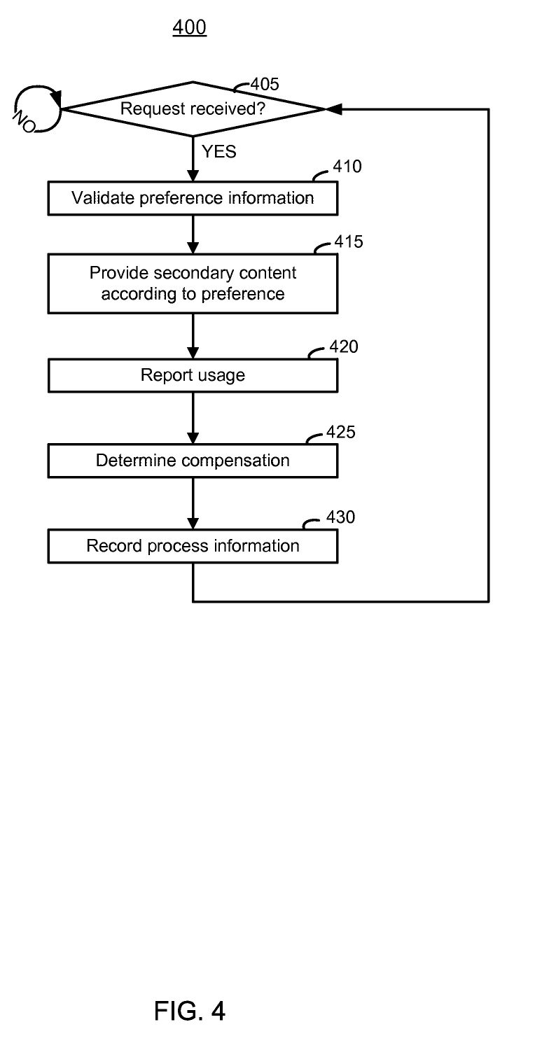

As illustrated in FIG. 4, a process 400 for providing secondary content and compensation information is provided. The process 400 may be performed in whole or in part by any suitable element of the system 100 (FIG. 1). In at least one embodiment, the process 400 is operative on a tracking server system such as the tracking server system 130 (FIG. 1).

In operation 405 (FIG. 4) a determination is made as to whether a request is received. If it is determined in operation 405 that a request is not received, control remains at operation 405 and process 400 continues. If it is determined in operation 405 that a request is received, control is passed to operation 410 and process 400 continues.

The determination in operation 405 may be made using various criteria. In at least one embodiment, if a message is received at a system associated with the tracking server system 130 (FIG. 1), it may be determined that a request is received. For example, if a GET request indicating an identifier of an user and/or a content provider is received at a server associated with the tracking server system 130, it may be determined that a request is received. Any type of message may be received which may indicate that a request is received. For example, reception of an SMS message, a mobile web message, a message from an App, etc., may be used to determine whether a request is received. A request may be received directly from a user device and/or may originate through an intermediary such as the content system 150. A request may include information which may be used to determine preferences and/or authorization associated with a user, advertiser, content provider, publisher and/or a request.

In operation 410, preference information is validated. For example, an identifier provided by a content provider may be compared to information of a user which may determine preferences associated with a user. If a user has established payment information, content preferences, etc. a request for content from a content provider may be determined to be validated. If validation information is provided by a content provider, confirmation of a content request may be obtained from a user. Control is passed to operation 415 and process 400 continues.

In operation 415, secondary content is provided according to preference. A tracking server system may elect to provide content based on implicit user preferences. For example, if a user has elected to block a particular type of advertisement, or to control an amount of information comprising secondary content, a tracking server system may provide secondary content which meets a user request and/or which meets an advertiser objective. Thus a user might provide some compensation to a content provider while receiving a limited subset of advertisements and/or other secondary content. A user might receive image based ads, but not pop-ups, or might receive ads which had high value while not receiving low CPM or CPC content. Control is passed to operation 420 and process 400 continues.

In operation 420, content usage is reported. Information of secondary content presented, advertisements selected, advertisements suppressed by preferences, etc., may be reported to advertisers, users, content providers, etc. Local storage of a user device may be modified based on usage information. Usage information may be aggregated when presented to various elements of the system 100 which may prevent sharing personally identifiable information. Control is passed to operation 425 and process 400 continues.

In operation 425, compensation is determined. Compensation for a provider of a tracking server system, a content provider, a user, and/or an advertiser may be determined based on usage information, content information, advertising information, bids, etc. Compensation may be obtained and/or provided in various ways. A user may provide advance payment against which usage information is reconciled on a periodic basis. Advertising compensation may be determined based on usage data, but may be affected by factors such as verification data. Compensation due to a content provider may be determined based on advertising revenues which have been provided for content delivered by a content provider, usage of content by users, payments by advertisers, users, etc. Control is passed to operation 430 and process 400 continues.

In operation 430, process information is recorded. Information of a request, a user, a publisher, a website, an advertiser, content, targeting parameters, user actions, compensation of a user, publisher, advertiser, etc., a rating, a ranking, etc. may be recorded. In at least one embodiment, process information is recorded in the database 120 (FIG. 1). Local information of a user device may be obtained and/or updated based on process information and/or information received from a tracking system server. Control is passed to operation 405 and process 400 continues.

Using the methods and systems described herein secondary content or elements of content provided responsive to a request may be selectively distributed responsive to requests for primary content. A provider of primary content or media may be compensated based on a measurement of content provided. Secondary content may include but is not limited to advertisements, surveys, polls, games, and/or other activities for which a provider of secondary content is willing to provide compensation to a provider of primary content. A provider of primary content and/or a publisher which provides primary content may provide primary content exclusive of secondary content based on preference or access information associated with a request for primary content. Compensation obtained from a source of a request for content may be determined based on compensation provided for presentation of secondary content when secondary content is published with that primary content.

A tracking server system may act as a provider of secondary content and/or may verify compensation provided by recipients of primary content and/or providers of secondary content which is presented. A tracking server may verify a user, confirm available compensation provided by a user, track usage data, cross-check content delivered by a publisher against content reported as received by a user, perform auction and/or pricing control for secondary content, and distribute compensation to content providers and/or publishers. A user device may track user preferences. A user device and may receive any content elements including primary content and/or secondary content based on verification information provided to a content provider. A content provider may obtain elements or secondary content based on information provided by a user device. A tracking server, which may be an ad server, may record compensation and/or provide advertisements and/or other elements of content based on verification information. Verification information may be provided by a user, a publisher, a content provider, etc.

User preferences may control which secondary content is provided. A user may selectively suppress any types of secondary content based on available compensation. If a user has not provided compensation to suppress secondary content, a user would experience a typical advertising supported user experience. However, based on user preferences, all advertisements might be suppressed, and/or advertisements might be suppressed based on a publisher, an advertiser, a type of advertisement, time of day, connection capacity, and/or any attributes of secondary content which may be provided by an advertiser and/or obtained by a tracking server system.

Metering of content and access rights may be controlled in various ways. Content metering may be performed in a manner similar to streaming media such as NetFlix, or Pandora wherein a monthly subscription fee is charged regardless of actual usage. Content metering may be similar to Apple iTunes® and/or the Google Play® store wherein a user purchases a fixed amount of content and must refill the purchase if a content limit is exceeded. Cost per unit of content may be determined in various ways. For example, more popular content might command a higher cost per view, in particular if comparable secondary content was not provided or published. Content access may be monitored by a browser extension, an App, and/or any suitable software operative on a user device. User identity may be obscured using anonymity controls to prevent traceability of primary content by a specific user.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal. Further, according to an aspect of the embodiments, any combinations of the described features, functions and/or operations can be provided.

The many features and advantages of the claimed invention are apparent from the detailed specification and thus, it is intended by the appended claims to cover all such features and advantages of the claimed invention that fall within the true spirit and scope of the invention. Further, since numerous modifications and changes will readily occur to those skilled in the art, it is not desired to limit the invention to the exact construction and operation illustrated and described for the disclosed embodiments, and accordingly all suitable modifications and equivalents may be resorted to, falling within the scope of the claimed invention. It will further be understood that the phrase “at least one of A, B and C” may be used herein as an alternative expression that means “one or more of A, B and C.”

What is claimed is:

1. A method comprising:
obtaining a request for content;
providing, by a processor, the content excluding an element based on authentication associated with the request;
delivering, by the processor, the content including elements comprising the element based on the authentication associated with the request; and
assigning compensation based on the excluding or the including.

2. The method of claim 1 further comprising:
obtaining an identifier of a source of the request; and
determining the authentication associated with the request based on the identifier.

3. The method of claim 1 further comprising:
procuring the element based on information provided by the request; and
determining the compensation based on a value assigned to the element.

4. The method of claim 1 further comprising:
assigning a unique identifier to a source of the request;
generating a variant based on the unique identifier when the request is received; and
authenticating the request based on the variant.

5. The method of claim 4 further comprising:
generating the variant based on a key computed for a previous query.

6. The method of claim 4 further comprising:
providing a random number to the source of the request prior to obtaining the request; and
generating the variant based on the random number and the unique identifier.

7. The method of claim 1 further comprising:
directing the request to an authentication device; and
providing the content based on a request to a content device by the authentication device.

8. The method of claim 1 further comprising:
selecting the element based on a provider of the content and the content; and
assigning the compensation based on a value assigned to the element by a source of the element.

9. The method of claim 1 further comprising:
delivering an algorithm to the source of the request; and
authenticating the request based on a unique random identifier assigned to the source of the request and the algorithm.

10. The method of claim 9 further comprising:
modifying the algorithm when the request is received.

11. The method of claim 9 further comprising:
modifying the unique random identifier when the request is received.

12. The method of claim 1 further comprising:
determining the compensation based on statistical information of user actions relating to the element when the content delivered comprises the element.

13. The method of claim 1 further comprising:
excluding the element when the element is specified by a source of the request; and
determining the compensation based on a value assigned to the element when the content comprising the element is provided responsive to requests.

14. The method of claim 1 further comprising:
including the elements when the elements are specified by a provider of the content.

15. A system comprising:
a user device receiving content and providing indications of actions taken by a user of the device; and
a content distribution server device comprising memory and a processor, obtaining a request for content, providing the content excluding an element based on authentication associated with the request, delivering the content including elements comprising the element based on the authentication associated with the request, and assigning compensation based on the including or the excluding.

16. The system of claim 15 further comprising:
a content provider device providing a portion of the content, indicating targeting data for the elements, and tracking requests for content.

17. A computer-readable medium having embodied therein a program for causing a computer to execute operations including optimization of user experience of users in a network, comprising:
obtaining a request for content;
providing the content excluding an element based on authentication associated with the request;
delivering the content including elements comprising the element based on the authentication associated with the request; and
assigning compensation based on the excluding or the including.

18. The computer-readable medium of claim 17, wherein the operations further comprise:
receiving a user preference;
determining the authentication based on the user preference, targeting information of the element, properties of the user, a bid associated with the user, and an auction based on the targeting information and a provider of a portion of the content.

19. The computer-readable medium of claim 17, wherein the operations further comprise:
directing the request to an authentication device; and
providing the content based on a request to a content device by the authentication device.

20. The computer-readable medium of claim 17, wherein the operations further comprise:
determining the compensation based on statistical information of user actions relating to the element when the content delivered comprises the element.
